(19) United States
(12) Patent Application Publication
(10) Pub. No.: US 2014/0143201 A1
(43) Pub. Date: May 22, 2014

(54) DYNAMIC CONTENT FILE SYNCHRONIZATION

(71) Applicant: INTERNATIONAL BUSINESS MACHINES CORPORATION, Armonk, NY (US)

(72) Inventor: Jinwoo HWANG, Cary, NC (US)

(73) Assignee: INTERNATIONAL BUSINESS MACHINES CORPORATION, Armonk, NY (US)

(21) Appl. No.: 13/681,642

(22) Filed: Nov. 20, 2012

(51) Int. Cl. G06F 17/30

(52) U.S. Cl. CPC G06F 17/30008
USPC 707/610

(57) ABSTRACT

Dynamic file synchronization is performed in a client server environment. A first file is received including a first portion containing metadata and a second portion containing at least one content object. An address and a protocol for accessing a second file are determined using the first portion of the first file. Upon accessing the second file using the address and the protocol, a determination is made as to whether synchronization is needed. Upon determining that synchronization is needed, the first and second files are synchronized.

### BACKGROUND

Content file synchronization is the process of harmonizing multiple copies of a file containing content (e.g. documents, images, videos, audio files). Synchronization between two files may be performed by identifying one file as the authoritative file, and replacing the non-authoritative file with the authoritative file. One method to determine the authoritative file compares timestamps and assigns the file with the later timestamp as the authoritative file. In some synchronization systems, one location (e.g. local or remote) contains the authoritative copy and the other location mirrors the authoritative copy.

Before performing synchronization, files are generally tested to determine if the files are already synchronized. There are many methods to determine whether two files are synchronized. One such method generates a value known as a fingerprint that is virtually unique. A hash algorithm is often used to generate a file fingerprint. If the file fingerprints of two files are equal, the files are said to be synchronized.

Local devices often have one or more synchronization applications that synchronize local files with files at a remote location. Typically, the local synchronization application maintains a synchronization list of folders and/or files to synchronize with a remote location. When the local device becomes connected to a synchronization service at a remote location, files are synchronized according to the synchronization list. For example, a handheld computer may have a synchronization application configured to synchronize all files in folder “A” when the handheld is connected to a synchronization service running on a workstation. Once the local device is connected, the synchronization repeats at some frequency (polling). Each individual synchronization application must be configured separately.

Many synchronization applications are configured to synchronize all files within one or more folders, with a configurable polling frequency (e.g. every five minutes, hourly, daily). A particular file is synchronized, not based on a user's unique needs for the file, but based on the synchronization configuration for the folder containing the file. The user must organize content around the limitations of the synchronization application rather than the user's preference. Further, testing for synchronization occurs with a polling frequency, and accordingly a file may be tested at each polling frequency, even if the file will not be accessed. Thus, there is a need to dynamically synchronize content files upon access, and configure synchronization on a file basis.

### SUMMARY

Provided are a method, computer program product, and system for dynamic synchronization of content. A first file is received including a first portion containing metadata and a second portion containing at least one content object. An address and a protocol for accessing a second file are determined using the first portion of the first file.

Upon accessing the second file using the address and the protocol, a determination is made as to whether synchronization is needed. Upon determining that synchronization is needed, the first and second files are synchronized.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing architecture in accordance with certain embodiments.

FIG. 2 illustrates, in a flow diagram, the process of file preparation, in accordance with certain embodiments.

FIG. 3 illustrates, in a flow diagram, the process of dynamic synchronization, in accordance with certain embodiments.

FIG. 4 depicts an example of two local files, each synchronized to a different synchronization service, in accordance with certain embodiments.

FIG. 5 illustrates, in a simplified block diagram, an exemplary hardware implementation of a computing system, in accordance with an embodiment of the invention.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvements over technologies found in the marketplace, or to enable others of ordinary skill in the art to understand the embodiments disclosed herein.

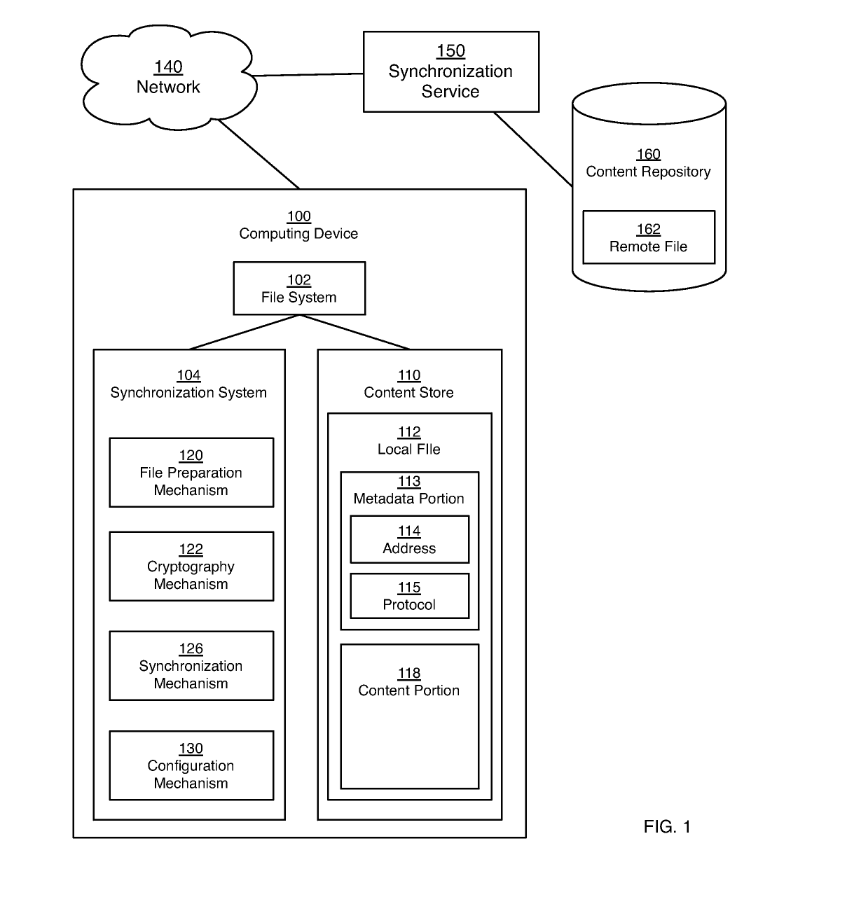

FIG. 1 illustrates, in a block diagram, a computing architecture in accordance with certain embodiments. A computing device 100 has a file system 102, synchronization system 104, and at least one content store 110. The file system 102 is coupled to the synchronization system 104 and the content store 110. The computing device 100 is coupled to a network 140, which is coupled to at least one synchronization service 150. The synchronization service 150 is coupled to at least one content repository 160 containing at least one remote file 162. The content store 110 contains a local file 112 containing a metadata portion 113 and a content portion 118. The metadata portion 113 contains an address 114 and protocol 115 to locate the remote file 162. In certain embodiments, the address 114 and protocol 115 correspond to the address of the synchronization service 150. In certain embodiments, the content portion 118 may include one or more content objects.

In certain embodiments, the name of the remote file 162 is part of the address 114. In certain embodiments, the synchronization system 104 is embodied in an application. In certain other embodiments, the synchronization system 104 is embodied in an operating system executing on the computing device 100; in these embodiments the synchronization system 104 would be available to all applications running on the computing device 100 under the control of the operating system. The synchronization system 104 may be embodied in an operating system using a custom device driver for the content store 110. Although FIG. 1 shows only one local file 112, a person skilled in the art will recognize that more than one local file 112 file can be added to the content store 110, and the local files may be organized in one or more folders (not shown).

The synchronization system 104 contains a file preparation mechanism 120, a cryptography mechanism 122, a synchronization mechanism 126, and a configuration mechanism 130. The content store 110 and content repository 160 may be implemented in storage media in one or more storage devices known in the art, such as interconnected hard disk drives (e.g., configured as a DASD, RAID, JBOD, etc.), solid state storage devices (e.g., EEPROM (Electrically Erasable Programmable Read-Only Memory), flash memory, solid state disks (SSDs), flash disk, storage-class memory (SCM)), electronic memory, etc. The content store 110 and the content repository 160 may be implemented in the same or different storage devices. The network 140 may comprise an interconnected network (e.g., Intranet, Internet, Local Area Network (LAN), Storage Area Network (SAN), etc.) or comprise direct cable connections between the separate computers implementing the components. In certain embodiments, the synchronization service 150 resides on the computing device 100 and a network 140 is not necessary for synchronization. In certain embodiments, the synchronization service 150 is a logical service performed by the file system 102 on the computing device 100.

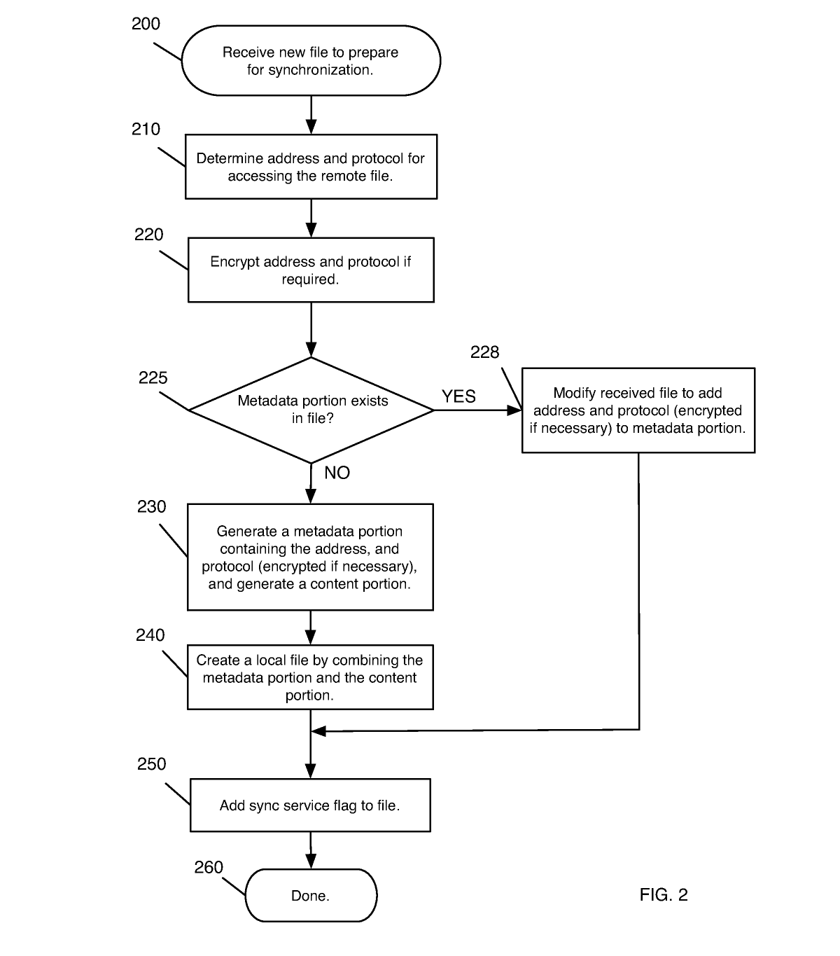

FIG. 2 illustrates, in a flow diagram, the process of file preparation, in accordance with certain embodiments. In block 200, a file to be prepared for the synchronization system 104 is received. In block 210, the address 114 and protocol 115 for accessing the remote file 162 is determined; in certain embodiments the configuration mechanism 130 provides a default address 114 and protocol 115; in certain other embodiments the address 114 and protocol 115 are provided to the synchronization system 104 based on the context (e.g. the address and protocol for the source of the file). Processing continues to block 220 where the address 114 and protocol 115 are encrypted with the cryptography mechanism 122. In certain embodiments the configuration mechanism 130 indicates when encryption is needed, and provides the encryption key. Processing continues to block 225 where a determination is made as to whether the received file contains a metadata portion 113 that may contain, or be modified to contain, the address 114 and protocol 115; if not then processing continues to block 230, otherwise processing continues to block 228 where the received file is modified to add the address 114 and protocol 115 (encrypted if necessary) to the metadata portion 113, and processing continues to block 250. In block 230 the file preparation mechanism 120 generates a metadata portion 113 containing the address 114 and protocol 115 (encrypted if necessary), and a content portion 118. Processing continues to block 240 where the file preparation mechanism 120 combines the metadata portion 113 and the content portion 118 to create a local file 112.

In block 250, the file preparation mechanism 120 adds a sync service flag to the file. The existence of the sync service flag indicates the file synchronization service 104 must process the file. In certain embodiments, a unique file extension (e.g. s_) is the sync service flag. In block 260, processing concludes. In certain other embodiments the flag may be contained in the file's metadata. In certain embodiments, configurable parameters are provided through a user interface and managed with the configuration mechanism 130. In certain embodiments, the configurable parameters include the conditions for encrypting the address 114 and protocol 115, as well as the algorithm and key(s) to use. In certain embodiments, the configurable parameters include the characteristics of files to be synchronized (e.g. specific file type, or those files containing a synchronization flag), and the conditions to perform synchronization (e.g. open file).

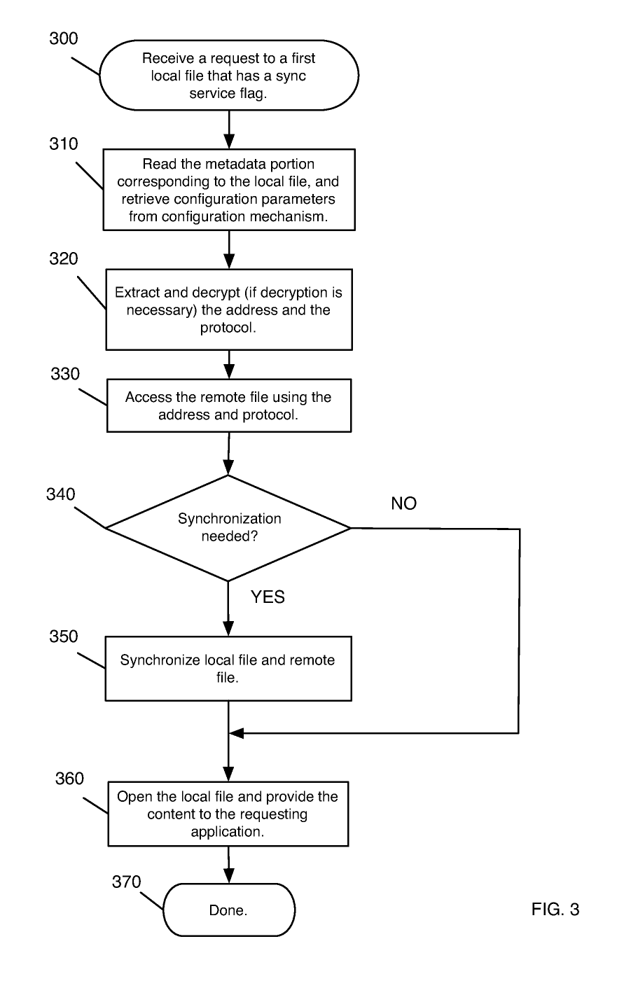

FIG. 3 illustrates, in a flow diagram, the process of dynamic synchronization, in accordance with certain embodiments. Control begins at block 300 with receiving a request to open a local file 112 that has a sync service flag. In certain embodiments, an application makes a request to the file system 102 to open a file; the file system 102 calls a custom device driver containing the synchronization system 104; the custom device driver determines if the sync service flag is present, and if so, provides the request to the synchronization system 104. In certain other embodiments, the application determines whether the sync service flag is present and if so passes the file to the synchronization system 104 for processing. Processing continues with block 310 where the metadata portion 113 of the local file 112 is read, and configuration information is retrieved from the configuration mechanism 130. In certain embodiments, the configuration information includes the file comparing property (e.g. file fingerprint, file timestamp) and directions for synchronization (e.g. synchronize only the portion changed, synchronize entire file, etc.). Processing continues to block 320 where the address 114 and protocol 115 are extracted from the metadata portion 113 and decrypted with the cryptography mechanism 122 if necessary. Processing continues to block 330 where the remote file 162 is accessed using the address 114 and protocol 115. In certain embodiments, the address 114 and protocol 115 are used to access a synchronization service 150 and certain characteristics (e.g. file name) of the remote file 162 are provided to the synchronization service 150 in order to access the remote file 162. Processing continues to block 340 where the remote file 162 and the local file 112 are compared according to the method provided by the configuration mechanism 130. In an embodiment, the comparison is made by comparing the fingerprints of the relevant portions of the files (e.g. the content portion of each file) and any difference in fingerprint would indicate that synchronization is needed. Other embodiments may use file timestamps, file size, or any file property that would be relevant to determine if the files are different. If the comparison indicates the synchronization is needed then processing continues to block 350, otherwise processing continues at block 360.

In block 350, the remote file 162 and the local file 112 are synchronized. In an embodiment, where the remote file 162 and the local file 112 contain metadata 113, the timestamps of the files are compared and copying is performed so that the file with the earlier timestamp is synchronized to match the file with the later timestamp. In another embodiment, the synchronization requires the local file 112 to mirror the remote file 162, notwithstanding the timestamp values; the local file 112 becomes a copy of the remote file 162. In another embodiment, the local file 112 contains a metadata portion 113 and a content portion 118, but only the content portion is synchronized with the remote file 162. Processing continues to block 360, where the local file is opened and the content is provided to the requesting application. In certain embodiments (particularly those where the metadata portion 113 is not part of the expected file format) the content portion 118 is provided and the metadata portion 113 is not provided. Process continues and is complete with block 370.

In certain other embodiments, the metadata portion 113 and the content portion 118 are not physically combined into a single file, but are separate files and logically combined; the file preparation mechanism 120 generates a separate file containing the metadata portion 113 and uses a hidden file to contain the corresponding content portion 118; the metadata portion 113 in this embodiment contains a pointer to the hidden file containing the content portion 118. In certain other embodiments, the local file 112 has an existing metadata portion 113 (e.g. header) that may contain additional parameters; in these embodiments file preparation mechanism 120 modifies the existing metadata portion 113 to include the address 114 and protocol 115.

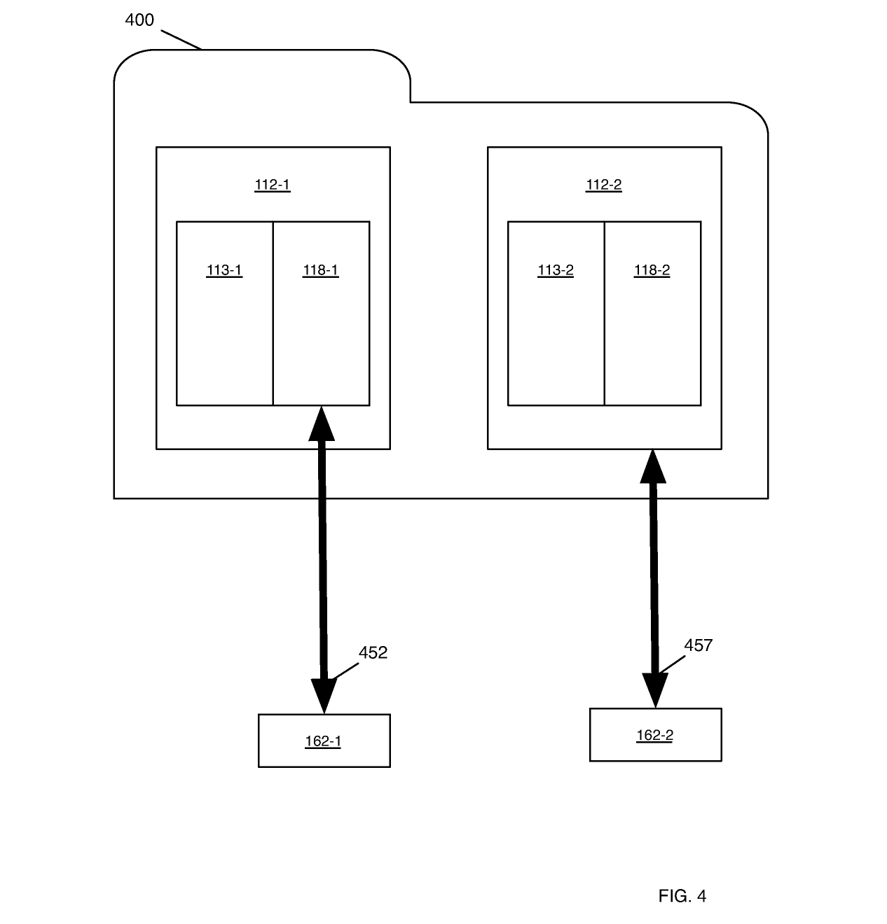

FIG. 4 depicts an example of two local files, each synchronized to a different synchronization service 150, in accordance with certain embodiments. In this example a file extension of “._s” or “.pdf” indicates the synchronization flag is set and the file should be processed by synchronization system 104. A local file system folder 400 contains two synchronized files, 112-1 and 112-2 named “image1.gif._s” and “doc.pdf” respectively. The synchronization system 104 is configured to synchronize the content portion of “.gif” files and synchronize entire .pdf files.

The synchronization system 104 determines if synchronization of file 112-1 is needed by using the address and protocol contained in the metadata portion 113-1. In this example 113-1 contains the address “backup.example.com/image1.gif” and the protocol “HTTP.” The address is used to access the remote file 162-1, through the synchronization service (not shown) associated with the remote file 162-1, to determine whether synchronization is needed. If synchronization is needed, the content object portion 118-1 is synchronized 452 with remote file 162-1.

File 112-1, “doc.pdf”, is in portable document format (PDF) containing metadata 113-2 and content 118-2. In this example, the synchronization system 104 reads the address “/zzz/doc.pdf” and protocol FILE contained in the metadata 113-2 (formatted with the extensible metadata platform XMP). In this example the synchronization service (not shown) is local at /zzz. The FILE protocol indicates the FILE system is used to access the remote file 162-2. In this example, the configuration mechanism 130 indicates that time stamps should be used to determine whether remote file 162-2 replaces file 112-2, or whether file 112-2 replaces remote file 162-2. In this example, remote file 162-2 is found to be a more recent copy (later timestamp) and file 112-2 is synchronized 457 by replacing file 112-2 with file remote 162-2 and updating the timestamp for file 112-2.

Previous approaches to synchronization of files used synchronization information separate from the file itself, usually contained in a list, or look-up table. Each previous synchronization application would address its own server synchronization service. Previous synchronization applications synchronized entire folders rather than enabling a file by file synchronization (without a look-up table). Previous solutions using polling synchronization did not provide dynamic “on-demand” synchronization and wasted computer resources synchronizing files that were not accessed. Local devices often spend considerable CPU, file system, and network resources polling each file within a folder to determine if synchronization is necessary. Providing the information needed to synchronize the content file with a remote content file enables the determination of whether to synchronize when the file is accessed.

Encrypting the address 114 and protocol 115 helps maintain the security of content synchronized and stored with the synchronization service 150. Existing systems require authentication information for accessing an address 114 be provided upon synchronization, or stored in a configuration file. An alternate approach is to use a unique address 114 and protocol 115 (that is not discoverable by a robot) and encrypt the address 114 and protocol 115. Anyone taking a synchronized file from a local machine will not be able to access updates without also having the decryption key to determine the address 114 and protocol 115.

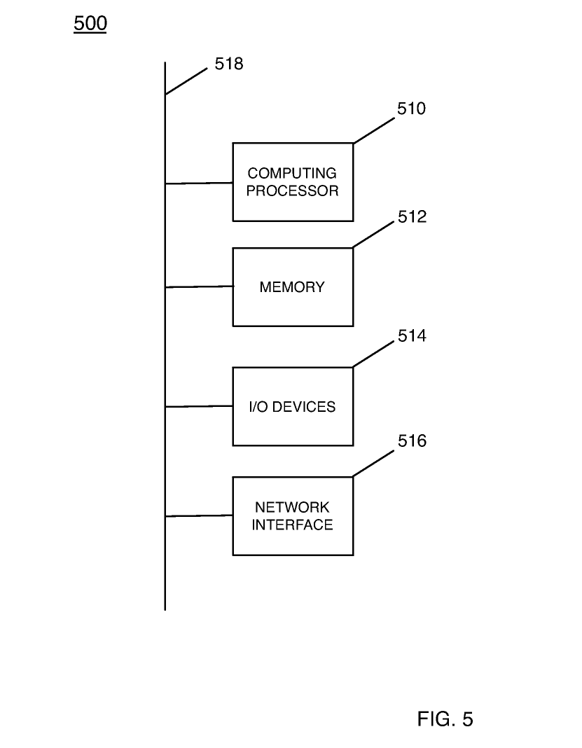

FIG. 5 illustrates, in a simplified block diagram, an exemplary hardware implementation of a computing system, in accordance with which one or more components/methodologies of the invention may be implemented, according to an embodiment of the invention.

As shown, the techniques for controlling access to at least one resource may be implemented in accordance with a computing processor 510, a memory 512, I/O devices 514, and a network interface 516, coupled via a computer bus 518 or alternate connection arrangement.

It is to be appreciated that the term “computing processor” as used herein is intended to include any processing device, such as, for example, one that includes a CPU (central processing unit) and/or other processing circuitry. It is also to be understood that the term “computing processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g. keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A method of file synchronization comprising:
receiving a first file including a first portion containing metadata and a second portion containing at least one content object, by at least one computing processor;
determining an address and a protocol for accessing a second file, using the first portion of the first file, by the at least one computing processor;
upon accessing the second file using the address and the protocol, determining if synchronization is needed, by the at least one computing processor; and
upon determining synchronization is needed, synchronizing the first file and the second file, by the at least one computing processor.

2. The method of claim 1, wherein determining if synchronization is needed further comprises:
comparing a file property of the first file and the second file.

3. The method of claim 1, wherein synchronization further comprises:
replacing the second file with the second portion of the first file.

4. The method of claim 1, wherein synchronization further comprises:
replacing the second portion of the first file with the second file.

5. The method of claim 1 further comprising:
decrypting the address and the protocol with a decryption key.

6. The method of claim 2, wherein the property is one or more of:
file fingerprint, file timestamp, and file size.

7. The method of claim 2, wherein accessing further comprises:
accessing a service with the address and protocol; and
providing the service with the property of the second file.

8. A computer program product for file synchronization, the computer program product comprising a computer readable storage medium having computer readable program code embodied therein, capable of being executed to perform operations comprising:
receiving a first file including a first portion containing metadata and a second portion containing at least one content object;
determining an address and a protocol for accessing a second file, using the first portion of the first file;
upon accessing the second file using the address and the protocol, determining if synchronization is needed; and
upon determining synchronization is needed, synchronizing the first file and the second file.

9. The computer program product of claim 8, wherein determining if synchronization is needed further comprises:
comparing a file property of the first file and the second file.

10. The computer program product of claim 8, wherein synchronization further comprises:
replacing the second file with the second portion of the first file.

11. The computer program product of claim 8, wherein synchronization further comprises:
replacing the second portion of the first file with the second file.

12. The computer program product of claim 8, further comprising:
decrypting the address and the protocol with a decryption key.

13. The computer program product of claim 9, wherein accessing further comprises:
accessing a service with the address and protocol; and
providing the service the file property of the second file.

14. The computer program product of claim 9, wherein, the property is one or more of:
file fingerprint, file timestamp, and file size.

15. A synchronization system comprising:
a processor; and
a memory containing program code which when executed by the processor is configured to perform an operation, comprising:
receiving a first file including a first portion containing metadata and a second portion containing at least one content object;
determining an address and a protocol for accessing a second file, using the first portion of the first file;
upon accessing the second file using the address and the protocol, determining if synchronization is needed; and
upon determining synchronization is needed, synchronizing the first file and the second file.

16. The system of claim 15, wherein determining if synchronization is needed further comprises:
comparing the file property of the first file and the second file.

17. The system of claim 16, wherein, the property is one or more of:
file fingerprint, file timestamp, and file size.

18. The system of claim 15, wherein synchronization further comprises:
replacing the second file with the second portion of the first file.

19. The system of claim 15, wherein synchronization further comprises:
replacing the second portion of the first file with the second file.

20. The system of claim 15, further comprising:
decrypting the address and the protocol with a decryption key.
